(19) United States
(12) Patent Application Publication
(10) Pub. No.: US 2013/0301681 A1
(43) Pub. Date: Nov. 14, 2013

(54) Frequency Hopping for Dynamic Spectrum Access

(71) Applicants: Amer A. Hassan, Kirkland, WA (US); Danny Allen Reed, Redmond, WA (US); Paul William Garnett, Albany, NY (US); Billy R. Anders, JR., Bothell, WA (US)

(72) Inventors: Amer A. Hassan, Kirkland, WA (US); Danny Allen Reed, Redmond, WA (US); Paul William Garnett, Albany, NY (US); Billy R. Anders, JR., Bothell, WA (US)

(73) Assignee: MICROSOFT CORPORATION, Redmond, WA (US)

(21) Appl. No.: 13/470,675

(22) Filed: May 14, 2012

(51) Int. Cl. H04B 1/69

(52) U.S. Cl. 375/132

(57) ABSTRACT

Described is a technology by which available radio frequency channels are switched/varied by communicating devices according to a frequency hopping pattern. The pattern may be a pseudorandom pattern, which may be weighted based at least in part on channel interference data. As also described herein, interference-related data may be used in a decoding scheme.

### BACKGROUND

In dynamic spectrum access (DSA) systems, a DSA-enabled communications device typically has an available a set of radio frequency (RF) channels to use for broadband communications. For example, while certain frequencies/channels are reserved for broadcast television, not all television channels are used in a given region; the frequencies corresponding to unused broadcast television channels, referred to as television whitespace, may be available for use by DSA systems.

Because the frequencies that are available thus vary according to location, a DSA-enabled device, referred to as a group owner, queries a regulatory database, including providing the group owner's current location data. The group owner receives a response that indicates which channels are available for use at that location (for an allowed duration, e.g., for the next twenty-four hours). The group owner selects an available channel and instructs client devices to use that channel for broadband communication until further notice. This selected channel may be subject to interference, however.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a plurality of available radio frequency channels is determined by a communications device, such as by querying a database. Data corresponding to the channels is provided to a client device. Switching among the plurality of available channels is performed according to a pattern, to communicate with the client device.

In one aspect, the pattern is obtained by generating a pseudorandom pattern and used for switching (frequency hopping). The pattern may be a weighted pattern based at least in part on channel interference data. Information corresponding to the interference data may be provided to a decoder.

In one aspect, a communications device includes a cognitive module configured to query a database with location information of the communications device and to receive a response identifying a plurality of available radio frequency channels at that location. A modulator, configured to transmit data over a selected channel to another device, is coupled to a frequency synthesizer that is configured to controllably vary which channel of the plurality of available radio frequency channels is the selected channel.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a frequency hopping system, including a group owner device configured to transmit data to a client device.

FIG. 2 is a block diagram showing example components of a frequency hopping system, including a client device configured to receive data from a group owner device.

FIG. 3 is a block diagram showing a representation of using interference-based reliability information in a decoding scheme.

FIG. 4 is a flow diagram representing example steps that may be taken to provide a frequency hopping with dynamic spectrum access.

FIG. 5 is a block diagram representing an example computing environment into which aspects of the subject matter described herein may be incorporated.

### DETAILED DESCRIPTION

Various aspects of the technology described herein are generally directed towards frequency hopping across the set of channels (or some subset thereof) that are available for use in a dynamic spectrum access system. As will be understood, frequency hopping mitigates (e.g., averages or otherwise reduces) possible interference to and from client devices, and may be used until the next database query, for example. When available, additional information regarding the channels with respect to detected interference levels may be considered by the frequency hopping technology described herein.

In one aspect, frequency hopping may be ordered according to the available channels, or may be based upon a pseudorandom sequence among the available channels. Moreover, the frequency hopping may shift to a correlated sequence based upon channel conditions. For example, one or more database queries and/or other measurement information may be used as input to a frequency hopping system to control the frequency hopping pattern, e.g., to provide for variable hopping pattern length and channels based upon a data driven frequency synthesizer. Also described is the use of detected interference in data transmission decoding schemes.

It should be understood that any of the examples herein are non-limiting. For example, while television whitespace provides one set of available channels that may be obtained by querying a regulatory database/(regulatory approved database), any frequencies may be used with the technology described herein, including frequencies in unlicensed or licensed bands. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in data communications in general.

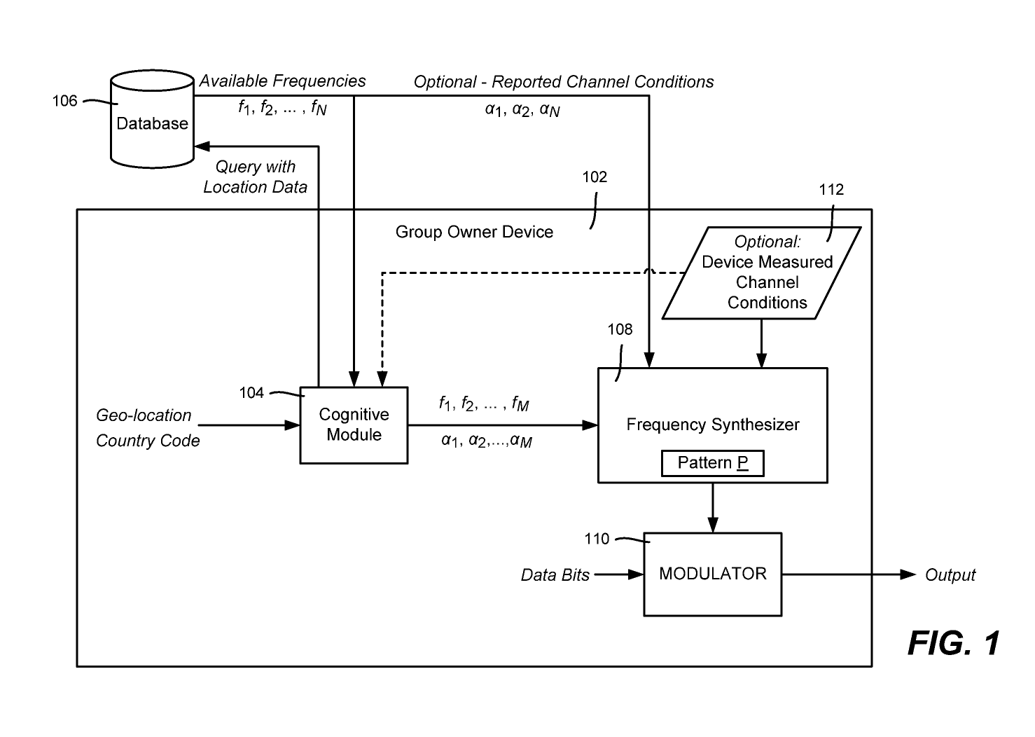

FIG. 1 shows a block diagram comprising an example DSA frequency hopping system, in which a group owner device 102 via a cognitive module 104 queries a regulatory database 106 or the like, providing the group owner's location data. The group owner device 102 may be any computing device configured with wireless communication capabilities, such as a personal computer system, a cell phone “tethering” configured device, a wireless access point, a base station, an appliance-type computing device, and so forth.

The regulatory database 106 returns a set of one or more channels available to the device 102 for communications. In most geographic areas, for television whitespace communications, a plurality of channels is returned, e.g., in the United States, the median number of such channels returned in response to a query is approximately nine. The channels are each identified by a center frequency represented in FIG. 1 by (f₁, f₂, . . . , f_{N}), where Nis the number of channels available; note that f₁, f₂, . . . , f_{N} do not necessarily represent contiguous frequencies. Further note that instead of or in addition to a regulatory database, for example, other databases including a private database may be used, such as for allowing sub-licensing of a service provider's unused part or parts of licensed channels.

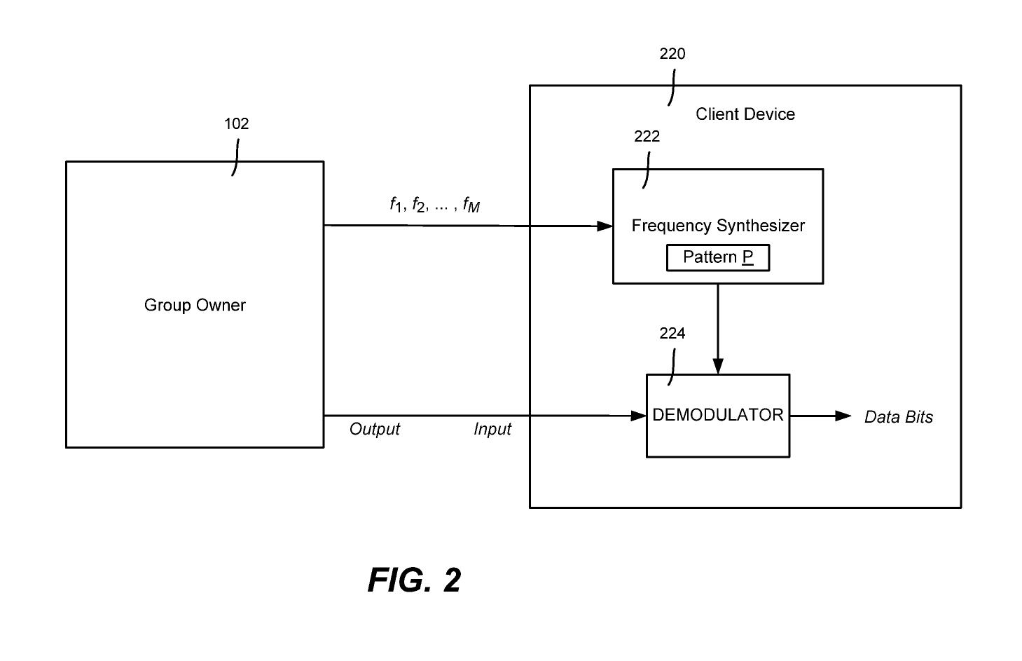

The group owner device 102 thus obtains the available channels that may be used in broadband communication with client devices, such as the client device 220 of FIG. 2. The cognitive module 104 may append this set of returned frequencies (f₁, f₂, . . . , f_{N}) with one or more frequencies that are available, e.g., in ISM (industrial, scientific and medical) or U-NII (Unlicensed National Information Infrastructure) bands, for example, and/or with or ones reported by other regulatory domains and the like. A service provider, for instance, may make part of a licensed spectrum available for sub-license. Thus, the total number of frequencies that may be used is represented in FIG. 1 by (f₁, f₂, . . . , f_{M}), where M is greater than or equal to the number N returned in the example query. Note that the group owner is able to communicate with the client device 220 over another communication path, such as to provide the list of available frequencies (f₁, f₂, . . . , f_{M}) to the client device 220.

In one aspect, the group owner device and client device may hop among these frequencies (f₁, f₂, . . . , f_{M}) in any order, such as basic pattern in the form of a fixed circular order, changing to the next frequency via a predetermined switching schedule. This averages out interference among the channels, and may be used by legacy devices by changing frequencies in a straightforward, deterministic manner.

In another aspect, the group owner device 102 may initialize a pseudo-random hopping pattern among the available frequencies (f₁, f₂, . . . , f_{M}), and provide the pseudo-random hopping pattern to the client device 220. In one implementation, the group owner device 102 and the client device 220 thereafter frequency hop among the channels according to the pseudo-random hopping pattern. To this end, in one example implementation, a frequency synthesizer 108 of the group owner device 102 of FIG. 1 receives the frequencies (f₁, f₂, . . . , f_{M}) along with a pseudo-random hopping sequence (such as maintained as a pattern P in a shift register or the like within the frequency synthesizer 108 or coupled thereto). The pattern thus shifts to the next frequency, e.g., based upon a schedule.

In FIG. 2, a counterpart frequency synthesizer 222 of the client device 220 receives the same information, provided by the group owner device 102, and similarly shifts on the same schedule. Thus, for transmission to the client device, the frequency synthesizer 108 of the group owner device 102 of FIG. 1 controls a modulator 110 according to the hopping pattern P; for reception at the client device, the counterpart frequency synthesizer 222 of the client device 220 controls a demodulator 224 according to the received copy of the hopping pattern P. Although not explicitly shown, it is understood that the communication including modulation and demodulation may similarly occur in the opposite direction from the client device 220 to the group owner device 102, (although it is feasible to use a different hopping pattern for different directions). Moreover, different clients may have different hopping patterns from one another, such as if a more complex group owner device, for example, has multiple modulators/demodulators with a frequency synthesizer (or synthesizers) that coordinates communication with each client.

Turning to another aspect, the database 106 also may return information about measured or known channel conditions for the group owner device's location, such as value added services reported to the database 106 by various devices, possibly in different locations. For example, the database 106 may return (f₁, f₂, . . . , f_{N}) and (α₁, α₂, . . . , α_{N}) or (α₁, f₁, α₂, f₂, . . . , α_{N}, f_{N}) where each α value represents a reported interference condition, (e.g., from zero to one, where the closer to zero, the more interference). As shown in FIG. 1, the interference-related information may be provided to the cognitive module 104, and/or to the frequency synthesizer 108; indeed, as is understood, any of the components herein are only examples, and the structure/functionality may be performed by separate components, combined components, additional components and/or a lesser number of components.

As described herein, the group owner device 102 may base and/or weight the hopping pattern according to the reported channel conditions. For example, the frequency synthesizer 108 may receive numeric information indicating that a particular channel B is less reliable than other available channels A and C, with C somewhat less reliable. The pattern thus may be configured to use channel B less often, and C somewhat less, such as proportional to reported conditions, e.g., A-C-C-A-C-A-B-A (and then repeat the pseudo-random sequence, providing four uses of channel A, three uses of channel C and one use of channel B for each sequence). It is also feasible to change the schedule to weigh the channels' usages differently, e.g., instead of the repeated A-C-C-A-C-A-B-A pattern above with one channel per time slot, channel A may be used for four time slots, channel B for one time slot, and channel C for three time slots to achieve a similar condition-based channel usage distribution. Note that to obtain such interference (corresponding to reliability) data, the database 106 may be communicated with as often as practical, with the pattern changed as desired based upon criteria such as power versus additional overhead to query and change, and the like.

In addition to or instead of database reporting of channel conditions, the cognitive module 104 may also adapt the frequencies that are available according to the device's own measurements 112, and/or possibly those reported by other sources (e.g., other clients). The frequency synthesizer 108 also may change the pattern or the like based upon such information. Thus, for example, if the database is not configured to report conditions, or is reporting conditions that differ from what the group owner node is currently experiencing, the hopping pattern may be changed to bias the system towards more efficient communication, e.g., dropping or reducing usage of a channel based upon measured conditions.

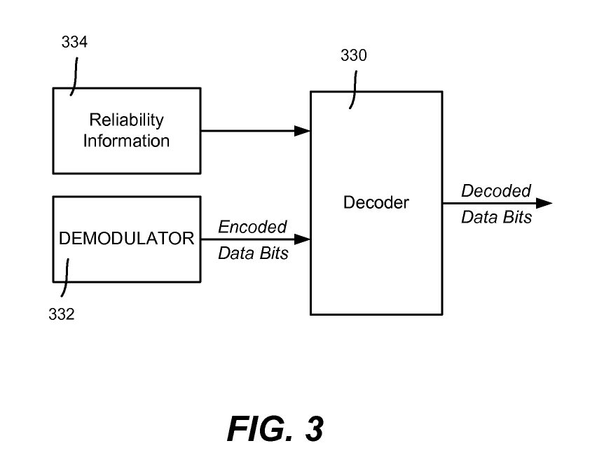

Turning to another aspect, interference condition (reliability) information may be used as described above, and/or also in a decoding scheme. FIG. 3 shows an example of one such decoder 330 in which the data is output from a demodulator 332 in a manner that is encoded with network coding techniques for processing into decoded data bits. The illustrated decoder 330 may be used at the group owner device 102 and/or at the client device 220 for decoding received data bits. Reliability information 334 such as corresponding to the interference information obtained from the database and/or otherwise measured is used by the decoder 330 in a known manner. For example, a soft decision Viterbi decoder may use such reliability information to compute soft values for use as likelihood data to weigh the possible paths in selecting the most likely one.

Alternatively, an erasure may be declared for any bits deemed unreliable, as determined from the interference information. The decoder 330 is thus able to perform erasure-based error correction based upon the interference information.

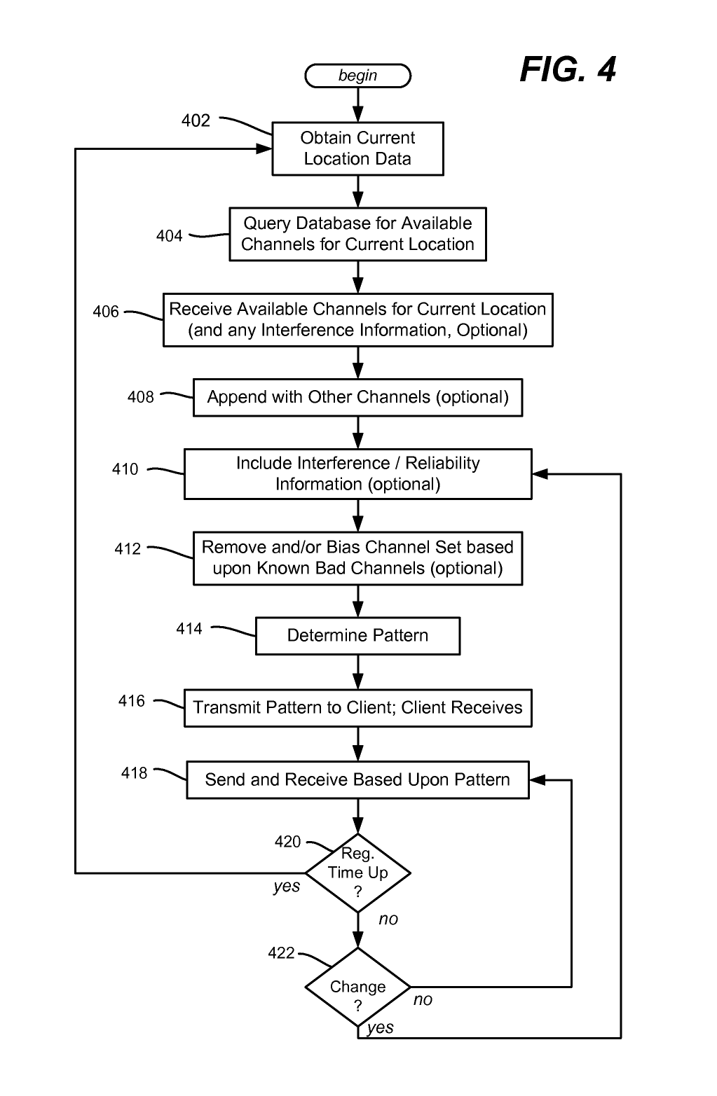

FIG. 4 is directed towards various example operations related to the technology described herein, beginning at step 402 where the communications device, e.g., the one that is to be the group owner, obtains its current location data. Step 404 represents querying at least one database to determine the available channels (frequencies) at the device's current location, which are received at step 406. Any database-provided interference information may also be received at step 406 (or possibly in response to a separate query).

Step 408 represents appending any other channels that are known to be available. As described above, such other channels may be determined in any way, such as from a separate query to a different database, and/or to include channels that are known to be available, e.g., public or already licensed.

Step 410 represents including any interference data in a communication to be sent to the client. This may comprise the alpha values obtained from any database as described above, and/or anything measured at the group owner device (or possibly a different device), or any values corresponding to the alpha values, e.g., some function thereof. Such values may be used in decoding, as described above.

Steps 412 and 414 represents removing and/or biasing some channels, and/or otherwise coming up with a pattern (an actual pattern of channels to cycle through or a channel usage timing pattern) for controllably switching the frequencies of the transmitting-side modulator and the receiving-side demodulator. As described above, the pattern may be as simple as to switch in order from the lowest to the highest frequencies (or vice-versa), may be a pseudorandom pattern, may be a pattern favoring one or more frequencies over others based upon interference data, and so forth. The pattern may be computed by the group owner and sent to the client device (step 416). Note that although not shown in FIG. 4, it is understood that alternatively, the client device and group owner may run the same algorithms given the same data so as to come up with matching patterns. In any event, the group owner and client device are synchronized so that each appropriately switches frequencies for communication with one another.

Step 418 represents the communications between the group owner and client device based upon the pattern. This continues as long as needed (although no explicit end is shown in FIG. 4 for purposes of brevity), but communication is subject to certain situational changes. One such change is that when the regulatory time allowed is up (e.g., every twenty-four hours), the group owner needs to again query the database, as represented by step 420. A significant location change of the group owner may also need a database re-query operation, and can similarly be handled by step 420 or the like. Note that if the database reports the same information, communication can continue as before, e.g., step 406 can skip to step 418 if the pattern (and any interference information) is the same.

Another example situation change may occur when interference information changes, such as represented in FIG. 4 at step 422. For example, as described above, the database may be queried as often as desired for updated interference information. Similarly, any measured conditions may be used to determine a new pattern, and/or provide updated interference/reliability information for use at the receiver's decoder.

As can be seen, there is provided a frequency hopping technology that may use database data to determine available frequencies and other data. Frequency hopping may be initiated with a pattern, such as a pseudorandom sequence of frequencies, which may shift (via variable hopping pattern length and/or channels) depending on channel conditions, which may be database dependent and/or based on measured conditions.

### Example Operating Environment

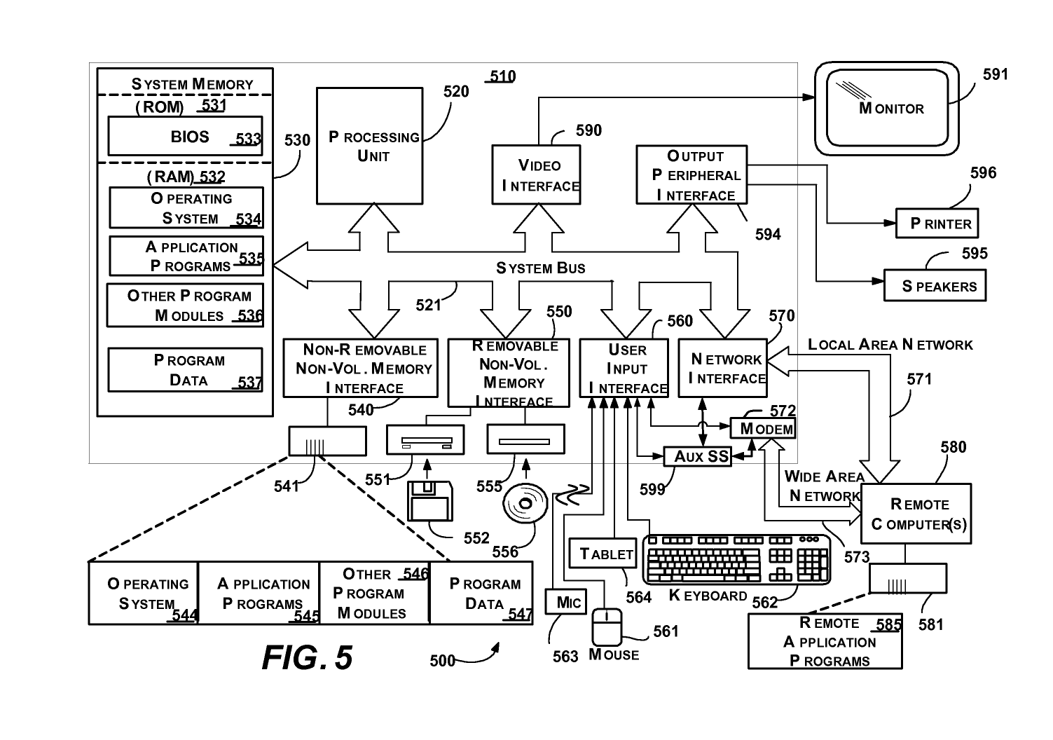

FIG. 5 illustrates an example of a suitable computing and networking environment 500 into which the examples and implementations of any of FIGS. 1-4 may be implemented, for example. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the example operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an example system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are examples and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. In a computing environment, a method performed at least in part on at least one processor comprising:
determining, by a group owner device, a plurality of available radio frequency channels based on a geographic location of the group owner device;
providing data corresponding to the plurality of available radio frequency channels to a client device; and
switching among the plurality of available radio frequency channels according to a pattern based on the data corresponding to the plurality of available radio frequency channels to communicate with the client device.

2. The method of claim 1 wherein determining the plurality of available radio frequency channels comprises querying one or more databases.

3. The method of claim 1 further comprising:
generating the pattern and providing information corresponding to the pattern to the client device.

4. The method of claim 3 wherein generating the pattern comprises generating a pseudorandom pattern.

5. The method of claim 3 further comprising:
obtaining interference data, and wherein generating the pattern comprises generating a weighted pattern based at least in part on the interference data, in which the weighted pattern uses at least one channel of the plurality having the interference data that indicates a lesser amount of interference more often than at least one other frequency of the plurality having the interference data that indicates a higher amount of interference.

6. The method of claim 5 wherein obtaining the interference data comprises receiving the interference data from a database.

7. The method of claim 5 wherein obtaining the interference data comprises measuring conditions corresponding to the interference data.

8. The method of claim 1 further comprising:
obtaining interference data; and
providing information corresponding to the interference data to a decoder.

9. The method of claim 8 wherein obtaining the interference data comprises receiving the interference data from a database.

10. The method of claim 8 wherein obtaining the interference data comprises measuring conditions corresponding to the interference data.

11. A system comprising:
a communications device, including a cognitive module configured to query at least one database with location information of the communications device and to receive a response identifying a plurality of available radio frequency channels at that location, a modulator configured to transmit data over a selected channel to another device, and a frequency synthesizer coupled to the modulator and configured to controllably vary which channel of the plurality of available radio frequency channels is the selected channel.

12. The system of claim 11 wherein the communications device receives interference information from the database, and wherein the frequency synthesizer varies channels based at least in part on the interference information.

13. The system of claim 11 wherein the communications device measures interference conditions, and wherein the frequency synthesizer varies channels based at least in part on the interference conditions.

14. The system of claim 11 wherein the communications device comprises a group owner device, and wherein at least one database comprises a regulatory approved database.

15. The system of claim 11 wherein at least one of the plurality of available radio frequency channels corresponds to a television whitespace.

16. The system of claim 11 wherein the communications device provides interference-related information for use in a decoding scheme.

17. One or more computer storage devices having computer-executable instructions, which in response to execution by a computer, cause the computer to perform steps, comprising:
receiving a set of channels from a group owner; and
varying which channel is used for communication with the group owner according to a pattern and channel conditions.

18. The one or more computer storage devices of claim 17 having further computer-executable instructions comprising:
receiving interference-related information, and using the interference-related information in decoding.

19. The one or more computer storage devices of claim 18 wherein using the interference-related information in decoding comprises providing soft likelihood data corresponding to interference data of at least one channel to a decoder.

20. The one or more computer storage devices of claim 18 wherein using the interference-related information in decoding comprises providing erasure data corresponding to interference data of at least one channel to a decoder.
